(19) United States
(12) Patent Application Publication
(10) Pub. No.: US 2026/0138249 A1
(43) Pub. Date: May 21, 2026

(54) TORQUE TOOL

(71) Applicants: WEN-JIN GUO, Taichung City (TW); OGC TORQUE CO., LTD., Taichung City (TW)

(72) Inventor: WEN-JIN GUO, Taichung City (TW)

(21) Appl. No.: 19/331,396

(22) Filed: Sep. 17, 2025

(30) Foreign Application Priority Data
Nov. 19, 2024 (TW) 113144394

(51) Int. Cl. B25B 23/142; B25B 23/14

(52) U.S. Cl. CPC B25B 23/1427; B25B 23/141

(57) ABSTRACT

A torque tool includes: a first rod including a groove and positioning portions; a second rod including a working end, a through hole and a receiving hole, the first rod extending through the through hole, the second rod further including a perforation, a retainer being disposed in the perforation; and a positioning assembly including a control member movably extending through the receiving hole, a positioning ball received in the perforation, and an elastic member between the receiving hole and the control member, the positioning ball being engageable against the retainer; wherein the control member is configured to push the positioning ball to snap into one positioning portion so that the first rod is unmovable; and when the control member is at the release position, or to disengage the positioning ball from the positioning portion so that the first rod is movable.

### BACKGROUND OF THE INVENTION

### Field of the Invention

The present invention relates to a driving tool, particularly to a torque tool.

### Description of the Prior Art

A cross-type torque wrench is typically used for removal and installation of automobile tires, especially during replacement and maintenance. The design of this wrench allows the length to be adjusted to vary the moment arm so as to adjust the magnitude of torque that a user can apply, thereby enabling different lever lengths to be used when tightening or loosening nuts and bolts.

A conventional cross-type torque wrench includes a first main body and a second main body. The first main body includes a slot and a receiving hole, and a detent member is disposed in the receiving hole. The second main body extends through the slot, and can be positioned relative to the second main body by the detent member at least partially entering the slot to effect detent positioning.

However, after the receiving hole of the conventional technology is machined, in order to prevent the detent member from completely coming out of the receiving hole, an additional step of pressing to narrow an opening at one end of the receiving hole must be performed. The narrowing process needs to consider the thickness, hardness, and ductility of the material, as well as the stress that the material can withstand during pressing, to avoid cracking and deformation. Therefore, the method presents machining difficulties.

The present invention is, therefore, arisen to obviate or at least mitigate the above-mentioned disadvantages.

### SUMMARY OF THE INVENTION

The main object of the present invention is to provide a torque tool with easy machining steps, and which can stop a positioning ball from coming out of a perforation by means of a retainer.

To achieve the above and other objects, a torque tool is provided, wherein the torque tool includes: a first rod being a torque rod, extending in a length direction, the first rod including a groove and a plurality of positioning portions recessed therein, the groove extending in the length direction and the plurality of positioning portions being spaced apart in the groove; a second rod including a working end, the second rod further including a through hole and a receiving hole in communication with each other, the first rod extending through the through hole, the second rod further including a perforation in communication with the through hole and the receiving hole, an inner wall of the perforation including an annular groove extending circumferentially, a retainer being disposed in the annular groove and at least partially radially protrusive beyond the annular groove; and a positioning assembly including a control member, a positioning ball and an elastic member, the control member extending through the receiving hole and being movable relative to the receiving hole between a locking position and a release position, the elastic member abutting between a first abutment surface of the receiving hole and the control member, the positioning ball being received in the perforation, an outer diametric dimension of the positioning ball being greater than an inner diametric dimension of the retainer, and the positioning ball being engageable against the retainer toward the through hole; wherein when the control member is at the locking position, the control member pushes the positioning ball to snap into one of the plurality of positioning portions so that the first rod is unable to move relative to the second rod; and when the control member is at the release position, the positioning ball is disengageable from one of the plurality of positioning portions so that the first rod is movable relative to the second rod.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is another perspective view of an exemplary embodiment of the present invention;

FIG. 4 is another exploded view of an exemplary embodiment of the present invention;

FIG. 5 is a schematic view showing a control member at a locking position in an exemplary embodiment of the present invention;

FIG. 6 is a schematic view showing the control member at a release position in an exemplary embodiment of the present invention;

FIG. 7 is a partially enlarged view of FIG. 6;

FIG. 8 is a partial cross-sectional view of an exemplary embodiment of the present invention; and

FIGS. 9 and 10 are schematic views showing the positioning ball snapping into different positioning portions in an exemplary embodiment of the present invention.

### DETAILED DESCRIPTION OF THE PREFERRED EMBODIMENTS

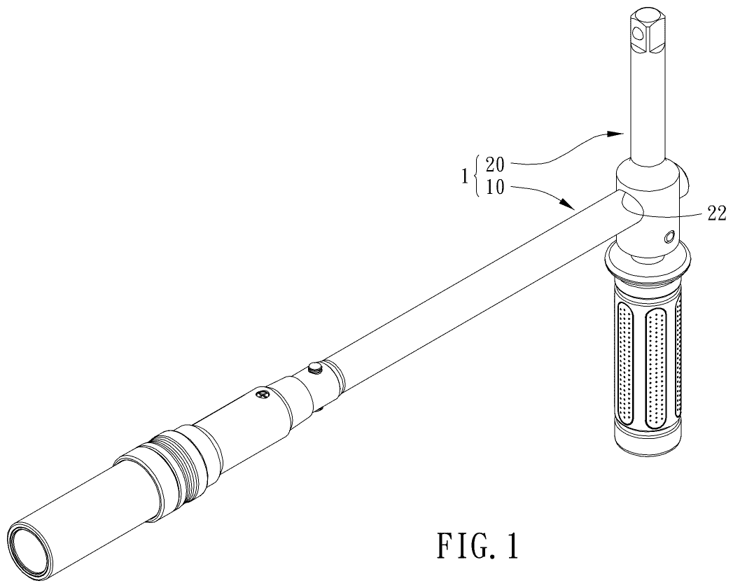

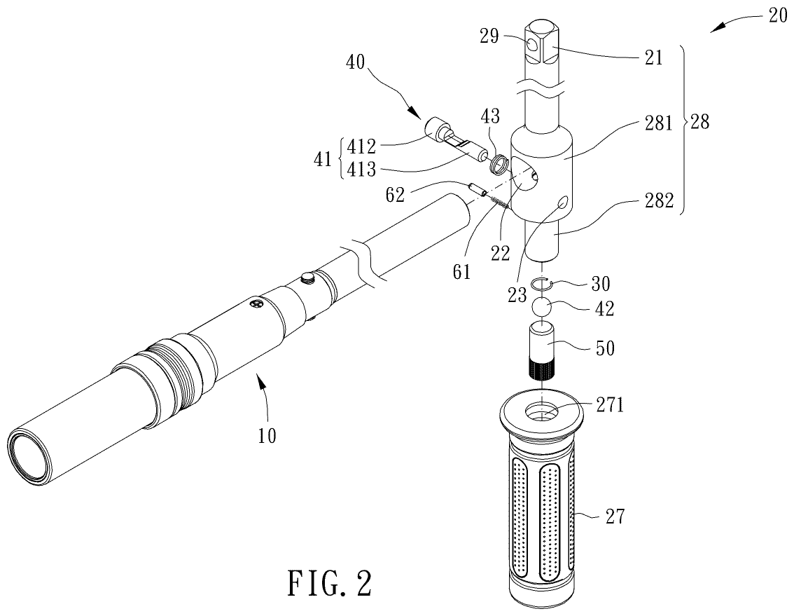

Please refer to FIGS. 1 to 10 for an exemplary embodiment of the present invention. A torque tool 1 of the present invention includes a first rod 10, a second rod 20, and a positioning assembly 40.

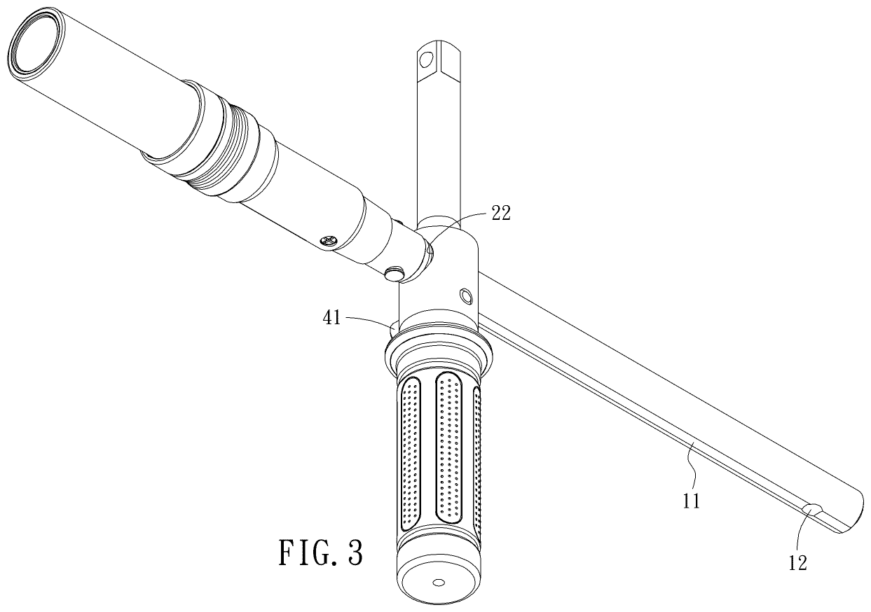

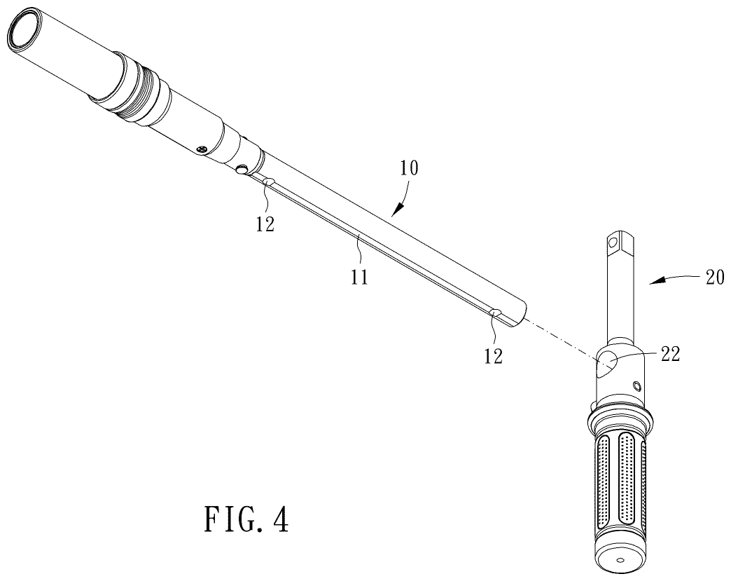

The first rod 10 is a torque rod and may include a torque mechanism such that, when the first rod 10 is subjected to a torque greater than a torque value, it slips. The first rod 10 extends in a length direction and includes a groove 11 and a plurality of positioning portions 12 recessed therein. The groove 11 extends in the length direction, and the plurality of positioning portions 12 are spaced apart in the groove 11 (see FIGS. 3 and 4). In this embodiment, each of the positioning portions 12 is an arcuate recess with a depth greater than a depth of the groove 11, and the number of the plurality of positioning portions 12 is two and they are respectively disposed at opposite ends of the first rod 10.

The second rod 20 includes a working end 21. In this embodiment, the working end 21 is a polygonal head (for example, a square head) and includes a detent ball 29 configured to be detachably coupled to a socket.

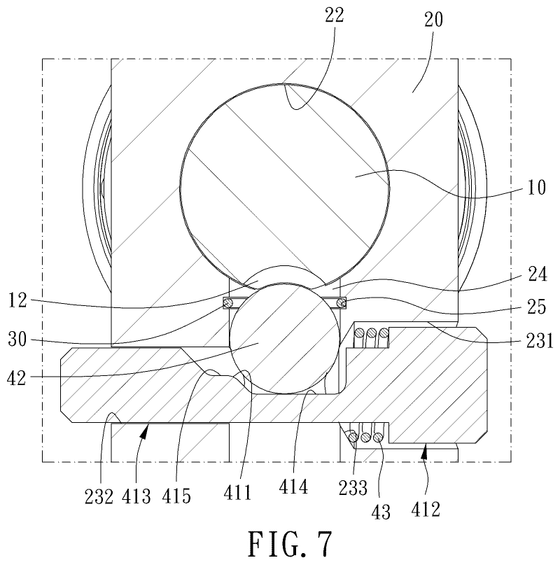

The second rod 20 further includes a through hole 22 and a receiving hole 23 in communication with each other in a radial direction, and the first rod 10 extends through the through hole 22. The second rod 20 further includes a perforation 24 in communication with the through hole 22 and the receiving hole 23. An inner wall of the perforation 24 includes an annular groove 25 extending circumferentially (see FIG. 7). In this embodiment, the annular groove 25 is an annular groove. A retainer 30 is disposed in the annular groove 25 and is at least partially radially protrusive beyond the annular groove 25. In this embodiment, the perforation 24 is perpendicular to the through hole 22 and the receiving hole 23, and the first rod 10 and the second rod 20 are assembled in a cross shape.

The positioning assembly 40 includes a control member 41, a positioning ball 42 and an elastic member 43. The control member 41 extends through the receiving hole 23 and is movable relative to the receiving hole 23 between a locking position and a release position (in an axial direction). The elastic member 43 elastically abuts between a first abutment surface 233 of the receiving hole 23 and the control member 41 (see FIG. 7). The positioning ball 42 is received in the perforation 24, an outer diametric dimension of the positioning ball 42 is greater than an inner diametric dimension of the retainer 30, and the positioning ball 42 is engageable against the retainer 30 toward the through hole 22 to stop the positioning ball 42 from coming out toward the through hole 22. Specifically, the elastic member 43 elastically abuts the control member 41 so that the control member 41 is normally at the locking position.

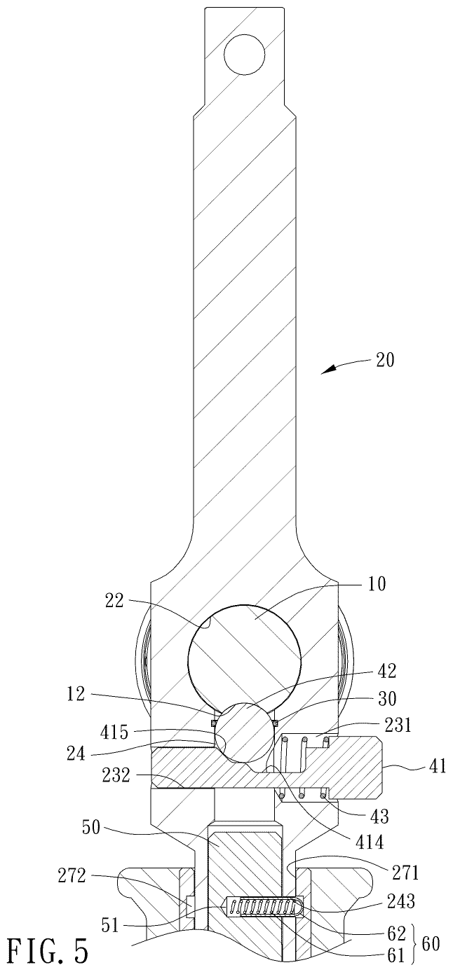

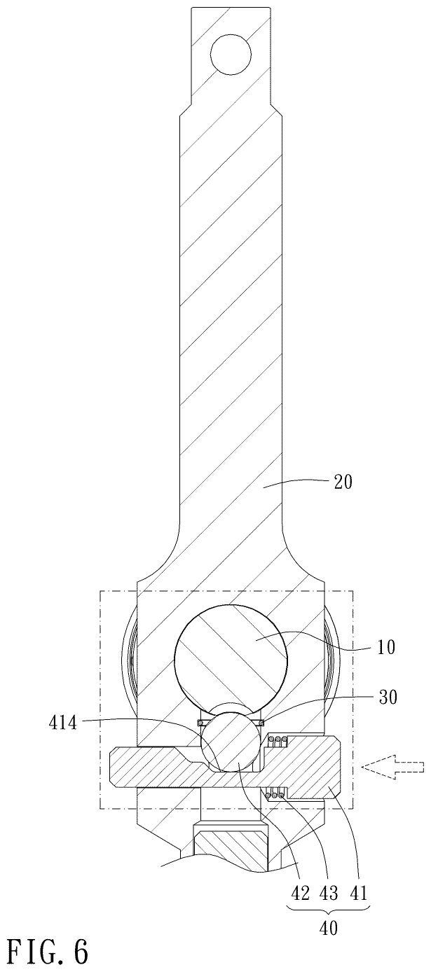

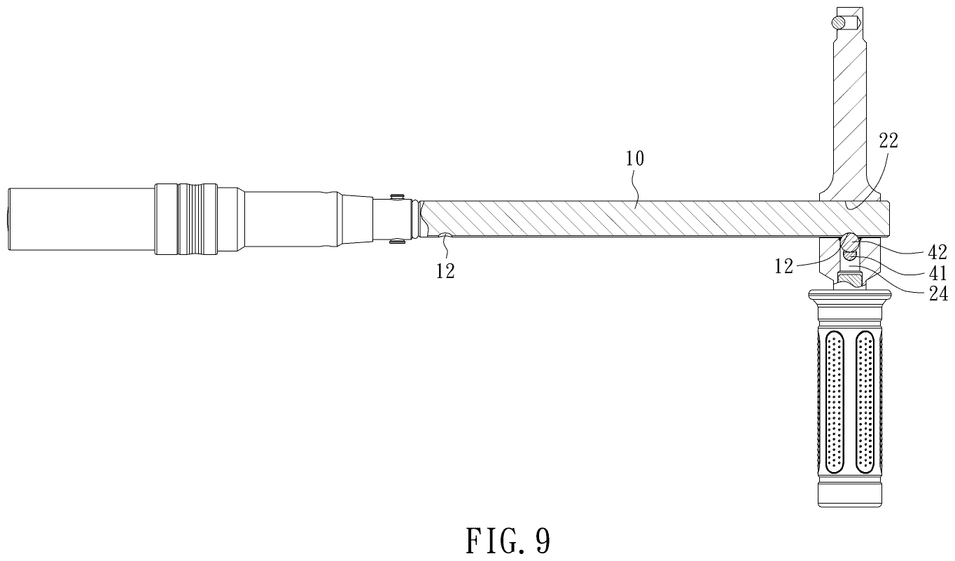

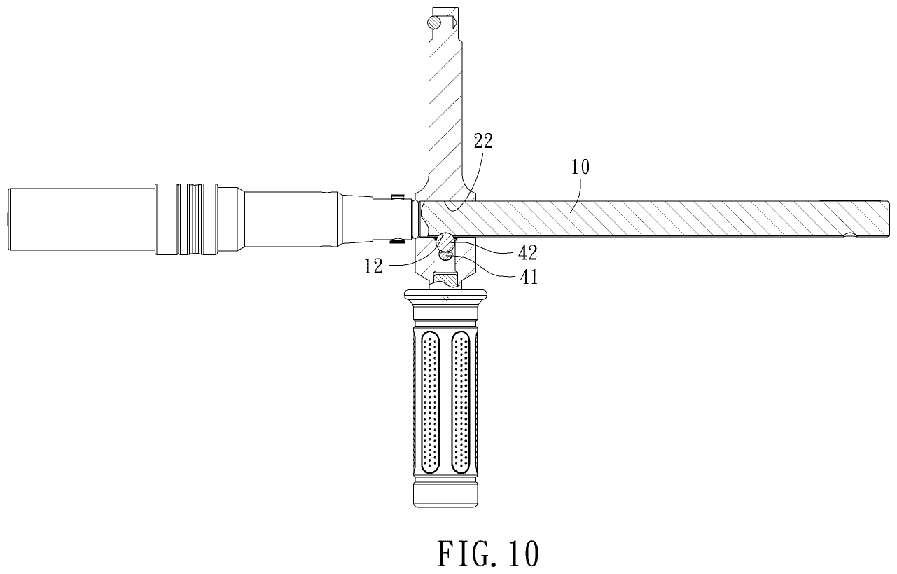

In actual use, when the control member 41 is at the locking position (see FIG. 5), the control member 41 pushes the positioning ball 42 to snap into one of the plurality of positioning portions 12 so that the first rod 10 is unable to move relative to the second rod 20. When the control member 41 is at the release position (see FIGS. 6 and 7), the positioning ball 42 is disengageable from one of the plurality of positioning portions 12 so that the first rod 10 is movable relative to the second rod 20. Therefore, the positioning ball 42 can be snapped to different positions of the first rod 10 for positioning (see FIGS. 9 and 10).

As such, it is only necessary to machine the annular groove 25 in the perforation 24 and install the retainer 30 in order to prevent the positioning ball 42 from coming out of the perforation 24 toward the through hole 22. Specifically, after the perforation 24 is opened, it is only necessary to use a tool to machine the annular groove 25, so machining is easy, installation is convenient, and cost is low. In addition, this design facilitates machining of a larger perforation 24 to accommodate a larger positioning ball 42, thereby providing a positioning effect with higher strength.

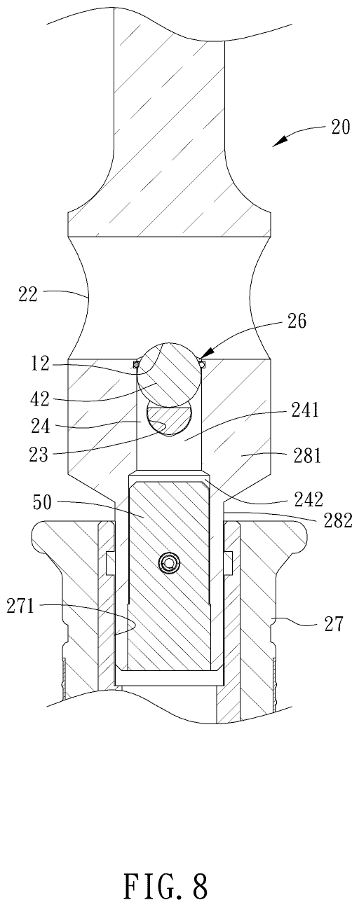

In this embodiment, the retainer 30 is a C-shaped snap ring. Specifically, the perforation 24 includes an opening 26 that is open toward the through hole 22 (see FIG. 8), the opening 26 is in communication with the through hole 22, and a diametric dimension of the opening 26 is greater than or equal to an outer diametric dimension of the positioning ball 42. Preferably, the annular groove 25 is disposed adjacent to the opening 26, an inner diametric dimension of the annular groove 25 is greater than a diametric dimension of the perforation 24, and an outer diametric dimension of the retainer 30 is greater than the diametric dimension of the perforation 24 and the diametric dimension of the opening 26. The positioning ball 42 can be placed into the perforation 24 from the opening 26, and the retainer 30 can be radially compressed to pass through the opening 26 into the perforation 24 and then radially elastically expand to snap into the annular groove 25, which facilitates installation.

In this embodiment, as shown in FIGS. 5 to 8, the receiving hole 23 includes a large diameter section 231 and a small diameter section 232 that are coaxially disposed and in communication with each other. The first abutment surface 233 is formed between the large diameter section 231 and the small diameter section 232. The control member 41 includes a first end portion 412 and a second end portion 413. An outer diametric dimension of the first end portion 412 is greater than an outer diametric dimension of the second end portion 413, and the first end portion 412 is disposed in the large diameter section 231. The second end portion 413 is disposed in the small diameter section 232 and includes a first stepped portion 414 and a second stepped portion 415. The first stepped portion 414 and the second stepped portion 415 have different depths. A second abutment surface 411 is formed between the first stepped portion 414 and the second stepped portion 415. When the control member 41 is at the locking position (see FIG. 5), the second stepped portion 415 pushes the positioning ball 42 to snap into one of the plurality of positioning portions 12. When the control member 41 is at the release position (see FIGS. 6 and 7), the first stepped portion 414 corresponds to the positioning ball 42 so that the positioning ball 42 is disengageable from one of the plurality of positioning portions 12. Thus, the control member 41 cannot come out of the receiving hole 23 and is smoothly movable axially relative to the receiving hole 23 such that the first stepped portion 414 or the second stepped portion 415 corresponds to the through hole 22. Preferably, the first abutment surface 233 tapers from the large diameter section 231 toward the small diameter section 232 so as to reduce wear between the elastic member 43 and the first abutment surface 233.

In this embodiment, the groove 11 is open axially toward an end of the first rod 10. Specifically, when the control member 41 is at the release position, the positioning ball 42 at least partially slightly projects into the through hole 22. When the first rod 10 is inserted into the through hole 22, the groove 11 can directly align with the positioning ball 42 and pass smoothly.

Preferably, the second rod 20 includes a grip 27 and a drive rod 28. The drive rod 28 includes the working end 21, an enlarged section 281, and a connection end 282. The enlarged section 281 is located between the working end 21 and the connection end 282. The enlarged section 281 includes the through hole 22, the receiving hole 23 and the perforation 24. The perforation 24 includes a narrow section 241 and an expanded section 242 which are coaxially disposed and in communication with each other. The expanded section 242 is open axially toward an end of the connection end 282. An inner diametric dimension of the expanded section 242 is greater than the outer diametric dimension of the positioning ball 42, and the connection end 282 is assembled with the grip 27. Specifically, a tool can pass through the expanded section 242 into the narrow section 241 to machine the annular groove 25.

In this embodiment, an end of the grip 27 includes an assembly hole 271, and the connection end 282 is rotatably assembled in the assembly hole 271. The connection end 282 is rod-shaped, can rotate relative to the grip 27, and has a large contact area with the grip 27 to provide stable support. An inner wall of the assembly hole 271 includes a guide groove 272. The second rod 20 further includes a reinforcement member 50 and a guide structure 60. The reinforcement member 50 is disposed in the expanded section 242. The reinforcement member 50 (columnar) is radially formed with a receiving hole 51. The receiving hole 51 corresponds to an opening 243 of the expanded section 242. The guide structure 60 is disposed in the receiving hole 51 and passes through the opening 243 to be snapped in the guide groove 272. The guide structure 60 includes an urging member 61 and a guide member 62. The urging member 61 elastically abuts between a wall of the receiving hole 51 and the guide member 62 and elastically urges the guide member 62 to snap into the guide groove 272, allowing the drive rod 28 to rotate smoothly relative to the grip 27 and reinforcing the hollow structure of the expanded section 242 by the reinforcement member 50.

Preferably, the receiving hole 23 is closer to the grip 27 than the through hole 22. As such, when holding the grip 27, a user can conveniently press the control member 41 to adjust a position of the first rod 10 relative to the second rod 20 without interference from the hand.

In the torque tool 1 of the present invention, by disposing the annular groove 25 and the retainer 30 in the perforation 24, the positioning ball 42 is stopped from coming out of the perforation 24, thereby making machining and assembly more convenient.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A torque tool including:
a first rod being a torque rod, extending in a length direction, the first rod including a groove and a plurality of positioning portions recessed therein, the groove extending in the length direction and the plurality of positioning portions being spaced apart in the groove;
a second rod including a working end, the second rod further including a through hole and a receiving hole in communication with each other, the first rod extending through the through hole, the second rod further including a perforation in communication with the through hole and the receiving hole, an inner wall of the perforation including an annular groove extending circumferentially, a retainer being disposed in the annular groove and at least partially radially protrusive beyond the annular groove; and
a positioning assembly including a control member, a positioning ball and an elastic member, the control member extending through the receiving hole and being movable relative to the receiving hole between a locking position and a release position, the elastic member abutting between a first abutment surface of the receiving hole and the control member, the positioning ball being received in the perforation, an outer diametric dimension of the positioning ball being greater than an inner diametric dimension of the retainer, and the positioning ball being engageable against the retainer toward the through hole;
wherein when the control member is at the locking position, the control member pushes the positioning ball to snap into one of the plurality of positioning portions so that the first rod is unable to move relative to the second rod; and when the control member is at the release position, the positioning ball is disengageable from one of the plurality of positioning portions so that the first rod is movable relative to the second rod.

2. The torque tool of claim 1, wherein the retainer is a C-shaped snap ring.

3. The torque tool of claim 1, wherein the perforation includes an opening open toward the through hole, the opening is in communication with the through hole, and a diametric dimension of the opening is greater than or equal to an outer diametric dimension of the positioning ball.

4. The torque tool of claim 3, wherein the annular groove is disposed adjacent to the opening, an inner diametric dimension of the annular groove is greater than a diametric dimension of the perforation, and an outer diametric dimension of the retainer is greater than the diametric dimension of the perforation and the diametric dimension of the opening.

5. The torque tool of claim 4, wherein the second rod includes a grip and a drive rod, the drive rod includes the working end, an enlarged section and a connection end, the enlarged section is located between the working end and the connection end, the enlarged section includes the through hole, the receiving hole and the perforation, the perforation includes a narrow section and an expanded section which are coaxially disposed and in communication with each other, the expanded section is open axially toward an end of the connection end, an inner diametric dimension of the expanded section is greater than the outer diametric dimension of the positioning ball, and the connection end is assembled with the grip.

6. The torque tool of claim 5, wherein the receiving hole is closer to the grip than the through hole.

7. The torque tool of claim 5, wherein an end of the grip includes an assembly hole, the connection end is rotatably assembled in the assembly hole, an inner wall of the assembly hole includes a guide groove, the second rod further includes a reinforcement member and a guide structure, the reinforcement member is disposed in the expanded section, the reinforcement member has a receiving hole extending radially, the receiving hole corresponds to an opening of the expanded section, the guide structure is disposed in the receiving hole and passes through the opening to be snapped in the guide groove, the guide structure includes an urging member and a guide member, and the urging member elastically abuts between a wall of the receiving hole and the guide member and elastically urges the guide member to snap into the guide groove.

8. The torque tool of claim 1, wherein the receiving hole includes a large diameter section and a small diameter section which are coaxially disposed and in communication with each other, the first abutment surface is located between the large diameter section and the small diameter section, the control member includes a first end portion and a second end portion, an outer diametric dimension of the first end portion is greater than an outer diametric dimension of the second end portion, the first end portion is disposed in the large diameter section, the second end portion is disposed in the small diameter section and includes a first stepped portion and a second stepped portion, the first stepped portion and the second stepped portion include different depths, a second abutment surface is located between the first stepped portion and the second stepped portion, when the control member is at the locking position, the second stepped portion pushes the positioning ball to snap into one of the plurality of positioning portions, and when the control member is at the release position, the first stepped portion corresponds to the positioning ball so that the positioning ball disengages from one of the plurality of positioning portions.

9. The torque tool of claim 8, wherein the first abutment surface tapers from the large diameter section toward the small diameter section.

10. The torque tool of claim 6, wherein the retainer is a C-shaped snap ring; the working end is a polygonal head and includes a detent ball; the receiving hole includes a large diameter section and a small diameter section which are coaxially disposed and in communication with each other; the first abutment surface is located between the large diameter section and the small diameter section; the control member includes a first end portion and a second end portion, an outer diametric dimension of the first end portion is greater than an outer diametric dimension of the second end portion and the first end portion is disposed in the large diameter section, the second end portion is disposed in the small diameter section and includes a first stepped portion and a second stepped portion, the first stepped portion and the second stepped portion have different depths, and a second abutment surface is located between the first stepped portion and the second stepped portion; when the control member is at the locking position, the second stepped portion pushes the positioning ball to snap into one of the plurality of positioning portions; when the control member is at the release position, the first stepped portion corresponds to the positioning ball so that the positioning ball disengages from one of the plurality of positioning portions; the first abutment surface tapers from the large diameter section toward the small diameter section; an end of the grip includes an assembly hole, the connection end is rotatably assembled in the assembly hole, and an inner wall of the assembly hole includes a guide groove; the second rod further includes a reinforcement member and a guide structure, the reinforcement member is disposed in the expanded section, the reinforcement member has a receiving hole extending radially, the receiving hole corresponds to an opening of the expanded section, the guide structure is disposed in the receiving hole and includes an urging member and a guide member, and the urging member elastically abuts the guide member to snap into the guide groove; and the groove is open axially toward one end of the first rod.
